(19) United States
(12) Patent Application Publication
(10) Pub. No.: US 2026/0321763 A1
(43) Pub. Date: Oct. 15, 2026

(54) HEAT TRANSFER FLUIDS

(71) Applicant: Midel & Mivolt Fluids Limited, Greater Manchester (GB)

(72) Inventors: Francine TOWNSEND, Greater Manchester (GB); Christopher INMAN, Greater Manchester (GB); Tom GALVIN, Greater Manchester (GB); Mark LASHBROOK, Greater Manchester (GB)

(21) Appl. No.: 19/104,502

(22) PCT Filed: Aug. 16, 2023
(86) PCT No.: PCT/EP23/72630

§ 371 Date: Feb. 18, 2025

(30) Foreign Application Priority Data
Aug. 19, 2022 (GB) 2212107.3
Jun. 27, 2023 (GB) 2309679.5

(51) Int. Cl. H01M 10/613; C09K 5/10; H01M 10/6552; H01M 10/6567

(52) U.S. Cl. CPC H01M 10/613; C09K 5/10; H01M 10/6552; H01M 10/6567

(57) ABSTRACT

Described herein is an electrical apparatus that includes at least one electrical component in thermal contact with a heat transfer fluid, including by weight percent of the fluid >95% at least one ester of a C₅-C₉ monocarboxylic acid and a C₅-C₉ monoalcohol having a carbon number of less than 17.

This invention relates to heat transfer fluids for use in transferring heat from one location to another, to electrical apparatus comprising such heat fluids, and to methods of using such heat transfer fluids in electrical apparatus.

The invention is particularly, although not exclusively, applicable to heat transfer fluids for use in environments where exposure to electricity may occur, and where low temperatures may exist.

The invention is illustrated in the following by reference to batteries, but the applicability of the invention is wider. For example, heat transfer fluids are used in transformers.

“Lithium plating” is a problem that can arise during the charging of lithium ion batteries. Lithium plating is the deposition of lithium on the anode surface, rather than the desired intercalation of lithium into the anode material. This occurs when lithium is deposited more rapidly than it can be intercalated into the anode, and so is dependent both on charging rate and the kinetics of intercalation of lithium into the anode material.

Lithium plating is exacerbated by operating batteries at low temperatures, as this results in reduced ion diffusion and electrolyte conductivity, increasing resistance, and slower kinetics of intercalation of lithium into the anode material. Lithium plating can lead to reduced battery capacity and, in the extreme, short circuiting.

Due to the increased internal resistance of cells at sub-zero temperatures and a slowing of the electro-chemical reactions it is therefore necessary to limit input current during battery charging. This in turn can lead to very long charging times for battery systems where the cell temperature is below 0° C.

To counteract this, it is beneficial to pre-heat battery cells during periods of cold ambient temperature to reach a more optimal temperature and to achieve a suitable fast charge rate.

Using an immersion cooled system provides an excellent thermal transfer between the pre-heating equipment and the battery cells. However the viscosity of some traditional thermal transfer liquids at sub-zero temperatures impedes the heat transfer due to excessive pressure drops in the system and a slowing of the liquid flow compared with higher temperatures. Extra energy is also required from pumping systems to circulate liquid at the higher viscosity experienced at low temperatures, and the pumps may need to be oversized to compensate.

A variety of heat transfer fluids are known and include for example hydrocarbons, fluorinated hydrocarbons, esters, and water/glycol mixtures.

Water/glycol mixtures need to be kept separate from operating electrical components, adding a thermal barrier between components and heat transfer fluid. Such water glycol mixtures may achieve a kinematic viscosity in the region of 100 mm²/s at −40° C. (see https://detector-cooling.web.cern.ch/data/Table %208-3-1.htm).

Hydrocarbons and fluorinated hydrocarbons do not have a good reputation for biodegradability.

Esters are known to be biodegradable to varying degrees and to provide good dielectric properties. The esters that have been suggested to date for heat transfer fluids include diesters, but their viscosity at e.g. −40° C. (~233° K) is too high to provide comparable performance to water/glycol mixtures or fluorinated hydrocarbons.

US2012/283162 A1 proposed the use of oleyl esters having 23 or more of a total number of a terminal methyl group, a methylene group and an ether group in a main chain, as a base oil for cooling electric motors.

US2022/0131205 A1 proposes the use of esters in a cooling composition for cooling, among other things, the battery and/or power electronics of an electric or hybrid vehicle. The only monoester exemplified is the highly branched 3,5,5-trimethylhexyl 3,5,5-trimethylhexanoate having 18 carbons and disclosed as having a viscosity at −25° C. of 55.8 mm²/s.

WO2010/116234 discloses a liquid heat exchange medium comprising 90 or more volume percent of 2-ethylhexyl caprylate (2-ethylhexyl octanoate) and permits presence of other esters of C6-C8 fatty acids with 2 ethyl hexanol.

The heat transfer fluids used in the present invention provide heat transfer properties comparable to fluorinated hydrocarbons, viscosity much lower than diesters and commonly used hydrocarbons, and are biodegradable. Further the source materials for the esters described herein are preferably obtainable from biological sources providing environmental benefits to their manufacture and use.

Accordingly, the present invention provides electrical apparatus comprising at least one electrical component in thermal contact with a heat transfer fluid, wherein the heat transfer fluid comprises by weight percent of the fluid >95% at least one ester of a C5-C9 monocarboxylic acid and a C5-C9 monoalcohol, the at least one ester having a carbon number of less than 17 the heat transfer fluid not comprising more than 80% by weight 2-ethylhexyl octanoate.

Optionally the at least one ester may comprise less than 60% by weight 2-ethylhexyl octanoate, less than 40% by weight 2-ethylhexyl octanoate, less than 20% by weight 2-ethylhexyl octanoate, less than 10% by weight 2-ethylhexyl octanoate, or less than 1% by weight 2-ethylhexyl octanoate. The at least one ester may be essentially free of 2-ethylhexyl octanoate. The C5-C9 monocarboxylic acid is optionally an acyclic monocarboxylic acid, for example a linear monocarboxylic acid or a branched monocarboxylic acid.

C5-C9 monocarboxylic acid may, as non-limitative examples, include any of pentanoic acid, hexanoic acid, heptanoic acid, octanoic acid, nonanoic acid, 2-ethylhexanoic acid, or 3,5,5-trimethylhexanoic acid.

The C5-C9 monoalcohol is optionally an acyclic monoalcohol, for example a linear monoalcohol or a branched monoalcohol and may be a primary, secondary, or tertiary alcohol. The C5-C9 monoalcohol when branched may comprise only methyl branches.

C5-C9 monoalcohol may, as non-limitative examples, include any of 2-pentanol, 3-pentanol, 2-hexanol, 3-hexanol, 2-heptanol, 3-heptanol, 4-heptanol, 2-octanol, 3-octanol, 4-octanol, 2-nonanol, 3-nonanol, 4-nonanol, 5-nonanol, isononanol, 7-methyloctan-1-ol, 2-ethylhexanol, or 3,5,5-Trimethyl-1-hexanol.

The electrical apparatus may comprise a heat source in thermal contact with the heat transfer fluid to permit heat to be transferred by the heat transfer fluid from the heat source to the at least one electrical component.

The electrical apparatus may comprise a heat sink in thermal contact with the heat transfer fluid to permit heat to be transferred by the heat transfer fluid from the at least one electrical component to the heat sink.

The at least one electrical component may be immersed in the heat transfer fluid.

The apparatus may be configured to supply heat to the at least one electrical component when the at least one electrical component is below a first temperature, and to remove heat from the at least one electrical component when the at least one electrical component is above a second temperature.

The at least one electrical component may comprise a battery, which may be a lithium ion battery, a lithium metal battery, or any other battery.

The heat transfer fluid in the apparatus may comprise by weight percent of the fluid >95% one ester of a C5-C9 monocarboxylic acid and a C5-C9 monoalcohol, and that one ester may be the only ester present Some of or each at least one ester in the heat transfer fluid optionally has a carbon number of 16 or less or 15 or less. Some of or each at least one ester in the heat transfer fluid optionally has a carbon number of 11 or more, or 12 or more, or 13 or more or 14 or more.

The heat transfer fluid in the apparatus may comprise one or more components selected from the group anti-oxidants, metal deactivators, friction modifiers, corrosion inhibitors, antifoam additives, detergents, extreme pressure additives, anti-wear additives, and thermally conductive particles.

A method of operating the electrical apparatus comprises transferring heat from the heat transfer fluid to the at least one electrical component, and operating the electrical component once a threshold temperature is exceeded.

Specific heat transfer fluids are claimed comprising by weight percent:—
>95% at least one ester of a C5-C9 monocarboxylic acid and a C5-C9 monoalcohol, the at
least one ester having a carbon number of less than 17
   and at least one functional additive selected from the group anti-oxidants, metal deactivators, friction modifiers, corrosion inhibitors, antifoam additives, detergents, extreme pressure additives, and anti-wear additives.

The functional additives may comprise by weight percent of the fluid:—
≥0.1% anti-oxidant
≥0.001% metal deactivator
   and optionally the functional additives may comprise by weight percent of the fluid:—
0.1-1.0% anti-oxidant
0.001-0.05% metal deactivator

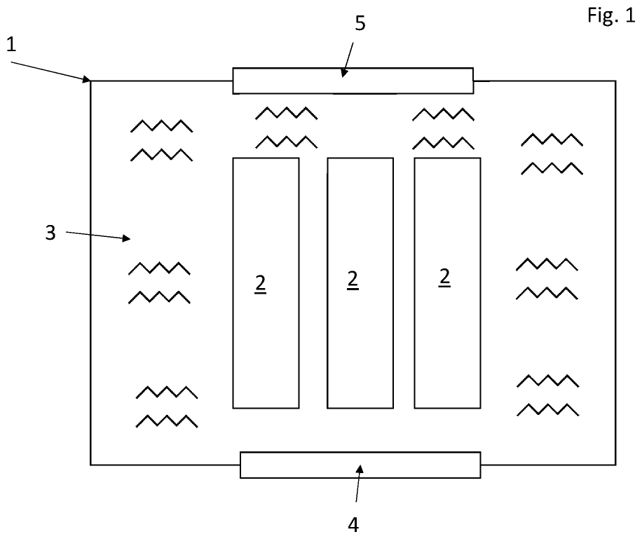

Further features of the invention will be apparent from the appended claims and the following description exemplifying, but not limiting, the scope of the invention claimed. Reference is made to FIG. 1 which shows schematically apparatus showing aspects of the invention as claimed.

In FIG. 1 apparatus 1 houses several electrical components 2 (batteries for example) that are immersed in and so in thermal contact with heat transfer fluid 3 that fills the apparatus. The apparatus comprises heat source 4 and heat sink 5.

Heat source 4 can provide heat to the heat transfer fluid 3, and thereby to the electrical components 2. The heat source can be any convenient source, for example an electrical heater, or a heat exchanger with a heating circuit carrying the same or different heat transfer fluid.

Heat sink 5 may absorb heat from the heat transfer fluid 3 to remove the heat from the apparatus. Heat may be removed in any convenient way, for example by radiation to ambient, heat exchange with a cooling circuit carrying the same or different heat transfer fluid.

The apparatus 1 is shown as a closed unit, with movement of the heat transfer fluid being by convection, but normally a pumped system will be required.

The heat transfer fluid is thus capable of transferring heat both to and from a part of the electrical apparatus.

The apparatus may be configured to transfer heat to the electrical components when the temperature of said part is below a threshold temperature. For example, a temperature sensor may be used to detect temperature in the apparatus and heat supplied as required to elevate the electrical components to the threshold temperature.

For batteries, having a dielectric liquid with a very low viscosity at −40° C. allows more effective transfer of heat from the pre-heating equipment to the battery cells, lower energy demand from pumps and the capability to specify smaller, lighter pumping equipment. This will speed pre-heating of the battery system and allow fast charging current to be applied sooner, as well as making the battery charging more efficient overall. This in turn has the potential to significantly reduce fast charging times under low ambient temperature conditions which brings significant advantages to consumers.

Potential applications include, but are not limited to:—
batteries in vehicles (including without limitation land, air, and marine vehicles);
stationary battery storage, e.g. batteries for storing renewable energy. Storage units are usually charged with surplus energy at night when it is colder and therefore the batteries may require preheating;
non-battery applications requiring a low viscosity, dielectric heat transfer fluid.

Performance as a heat transfer fluid depends upon a number of factors, and the Mouromtseff number (Mo) can give an indication of the heat transfer capabilities of fluids.

$$Mo = \frac{{ρ}^{a} {k}^{b} {C}_{p}^{d}}{{μ}^{e}}$$

Where ρ is the density, k is the thermal conductivity, Cp is the specific heat and is the dynamic viscosity of the heat transfer fluid.

The exponents a, b, d and e are system dependent and will differ according to whether there is turbulent flow or laminar flow; but for a defined system provide a means of comparison between heat transfer fluids. The higher the Mo number the better the heat transfer capabilities of the fluid in that system.

Of note, the denominator is a function of dynamic viscosity which (over a short range of temperatures and absent any phase changes) can be expected to vary more with temperature than the other factors.

Table 1 below shows properties for a range of fluids including:—
the monoesters of the present invention (shown in Part 1 of the Table);
monoesters not in accordance with the present invention;
diesters, not in accordance with the present invention; and
known non-ester heat transfer fluids.

The properties shown [indicating units and methods used] are:
Carbon number (for esters)
Density at 20° C. [kg/dm³—ISO 3675]
Specific Heat at 20° C. [J/kg K—ASTM D2766]
Thermal Conductivity at 40° C. [W/m·K—ASTM D7896]
Kinematic Viscosity at 40° C. [mm²/s—ISO 3104]
Kinematic Viscosity at −30° C. [mm²/s—ISO 3104]
Kinematic Viscosity at −40° C. [mm²/s—ISO 3104]
Pour Point [° C.—ISO 3016]
Flash Point [° C.—ISO 2719]

Where values are shown with an asterisk * values are estimated or from commercial product data.

TABLE 1
part 1

| | 2-Octanol + | 2-octanol + | 2-octanol + | 2-hexanol + | isononanol† + | 2-ethylhexanol + | 2-octanol + | 2-ethylhexanol + 2- |
|---|---|---|---|---|---|---|---|---|
| General | pentanoic | hexanoic | heptanoic | nonanoic | hexanoic | heptanoic | octanoic | ethylhexanoic |
| Properties | acid | acid | acid | acid | acid | acid | acid | acid |
| Carbon number | C13 | C14 | C15 | C15 | C15 | C15 | C16 | C16 |
| Density at 20° C. | | 0.86 | 0.86 | 0.85 | | | 0.85 | 0.86 |
| Specific Heat at | | | 1764 | | | | | |
| 20° C. | | | | | | | | |
| Thermal | | | 0.136 | | | | | |
| Conductivity at | | | | | | | | |
| 40° C. | | | | | | | | |
| Kinematic | | 2.3 | 2.6 | 2.7 | | | 3.1 | |
| Viscosity at 40° C. | | | | | | | | |
| Kinematic | | 16 | 21 | 23 | | | 30 | 40 |
| Viscosity at −30° C. | | | | | | | | |
| Kinematic | 27 | 29 | 41 | 43 | 51 | 46 | 58 | 87 |
| Viscosity at −40° C. | | | | | | | | |
| Pour Point | <−90 | <−90 | −96 | −87 | −70 | <−90 | −96 | −80 |
| Flash Point | 112 | 140 | 142 | 148 | 142 | 148 | 154 | 144 |

part 2

| | C17 and more monoesters | | | Diesters | | |
|---|---|---|---|---|---|---|
| | | 2-Octanol + | isononanol + | Ethylene | Ethylene | Neopentyl |
| | 2-octanol + | 3,5,5- | 3,5,5- | glycol + | glycol + | glycol + |
| General | isononanoic | trimethylhexanoic | trimethylhexanoic | heptanoic | 2-ethylhexanoic | 2-ethylhexanoic |
| Properties | acid | acid‡ | acid‡ | acid | acid | acid |
| Carbon number | C17 | C17 | C18 | C16 | C18 | C21 |
| Density at 20° C. | | | | | | 0.92 |
| Specific Heat at | | | | | | 1907 |
| 20° C. | | | | | | |
| Thermal | | | | | | 0.13 |
| Conductivity at | | | | | | |
| 40° C. | | | | | | |
| Kinematic | 3.2 | | | 4.2 | 5 | 7.7 |
| Viscosity at | | | | | | |
| 40° C. | | | | | | |
| Kinematic | 62 | | | N/A | 243 | 510 |
| Viscosity | | | | | | |
| at −30° C. | | | | | | |
| Kinematic | 139 | Frozen | 180 | N/A | 1170 | 1604 |
| Viscosity | | | | | | |
| at −40° C. | | | | | | |
| Pour Point | | <−46 | | −9 | | −75 |
| Flash Point | 152 | 156 | 152 | 174 | 182 | 194 |

part 2

| | Diesters | Non-ester heat transfer fluids | | |
|---|---|---|---|---|
| General | 2-ethylhexanol + | Water/Glycol | ethoxy- | Polyalphaolefin - |
| Properties | adipic acid | 48:52 | nonafluorobutane | PAO 2 |
| Carbon number | C22 | | | |
| Density at 20° C. | 0.93 | | 1.42 | 0.81 |
| Specific Heat at | | | 1220 | 2129 |
| 20° C. | | | | |
| Thermal | 0.13 | | 0.07 | 0.14 |
| Conductivity at | | | | |
| 40° C. | | | | |
| Kinematic | 7.7 | | 0.36 | 5.1 |
| Viscosity at | | | | |
| 40° C. | | | | |
| Kinematic | | | | |
| Viscosity | | | | |
| at −30° C. | | | | |
| Kinematic | 808* | 100* | 1.57* | 277 |
| Viscosity | | | | |
| at −40° C. | | | | |
| Pour Point | −81 | | −138 | −55 |
| Flash Point | 203 | | N/A | 166 |

†isononanol from Evonik - 7-methyloctanol major isomer
‡3,5,5 trimethylhexanoic acid major isomer

It can be seen that the C5-C9/C5-C9 monoesters with carbon number less than 17 of the present invention show much lower viscosities at −40° C. than the diesters, poly-alphaolefins, or C17 and above monoesters.

Although having lower or comparable viscosity to a water/glycol mixture (100 mm²/s), the esters claimed are dielectric materials permitting direct contact with electrical components. Further having lower or comparable viscosity to a water/glycol mixture enables use of pumps with similar pumping power rather than requiring higher rated pumps.

Although having viscosities higher than the exemplified fluorinated material, the esters claimed have higher thermal conductivity and specific heat (beneficial for heat transfer as can be seen from the Mouromtseff number equation given above); are environmentally safer, being biodegradable; and further the alcohols and acids from which the esters are made are obtainable from renewable sources.

Below carbon number 14 the flash point drops and so carbon numbers of 14 or more may be preferable in some applications.

The above shows the utility of esters as claimed as heat transfer fluids.

Advantageously the ester has the formula R₁COOR₂ wherein R₁ and R₂ are each hydrocarbon moieties which may be the same or different Aliphatic moieties are preferred over aromatic moieties and acyclic moieties are preferred over cyclic moieties. Unsubstituted aliphatic moieties are preferred over substituted aliphatic moieties. Aliphatic moieties may be saturated or unsaturated.

The environment in which the heat transfer fluid is used may require the provision of additives to protect the fluid or components in which it is in contact.

Additives may include any of antioxidants, metal deactivators, friction modifiers, corrosion inhibitors, antifoam additives, thermally conductive particles or combinations thereof.

Antioxidants limit degradation of the ester. Antioxidants may include, but are not limited to:
Phenol antioxidants, for example, 2,6-di-tert-butyl-4-methylphenol; 2,6-di-tert-butylphenol; 4,4′-Methylenebis (2,6-di-tertbutylphenol); pentaerythritol tetrakis(3-(3,5-di-tert-butyl-4-hydroxyphenyl)propionate) and butylated hydroxyanisole
Aromatic amines, for example phenyl alpha naphthylamines and alkylated diphenylamines

Metal deactivators limit degradation of the ester or attack on components. Metal deactivators may include but are not limited to triazole-based deactivators, for example Irgamet® 30, Irgamet® 39, Irgamet® BTZ and Irgamet® TTZ (commercially available from BASF).

Friction modifiers limit surface effects with surfaces in contact with the heat transfer fluid. Friction modifiers may include but are not limited to: high hydroxyl esters, boron derivatives, cyclic and acyclic amides.

Corrosion inhibitors limit corrosion of surfaces in contact with the heat transfer fluid. Corrosion inhibitors may include but are not limited to: dimercaptothiazoles, mercaptobenzothiazole, triazoles, imidazoles, alkyl amines, amine phosphates, and sulphonates Antifoam additives limit foaming of the heat transfer fluid. Antifoam additives may include but are not limited to: polyacrylates, and alcohols.

Detergents may limit separation of components in the heat transfer fluid or assist in the suspension of any particulate matter. Detergents may include but are not limited to: phosphate esters, sulphonates, phenates and salicylates

In some applications extreme pressure additives may be required. Extreme pressure additives may include but are not limited to: graphite, carbon-based nanomaterials, molybdenum disulphide, olefin sulphides, and dithiocarbamates.

In some applications anti-wear additives may be required to prevent mechanical damage to surfaces that the heat transfer fluid is in contact with. Anti-wear additives include but are not limited to: metal alkylthiophosphates, ashless dithiophosphates, ashless phosphorothioates, ashless thiophosphates, amine phosphates, triarylphosphates, high hydroxyl esters, sulphurised esters, cyclic and acyclic amides, dimer acids and boron derivatives.

In some systems heat transfer may be improved by including thermally conductive particles in the heat transfer fluid. Thermally conductive particles may include, but are not limited to: graphite, carbon-based nanomaterials, and boron nitride

Esters are commonly known compounds and can be manufactured by any suitable process fit for producing esters.

On a laboratory scale, alcohol and carboxylic acid (1 equivalent) may be added to a round bottom flask fitted with a Dean-Stark trap and a condenser. The reaction mixture may be heated up to 240° C. under nitrogen, held there for 4 hours and water collected in the Dean-Stark trap. Any excess alcohol or carboxylic acid can then be removed using reduced pressure fractional distillation.

Modifications and variants to the above disclosure will be evident to the person skilled in the art, yet still remain within the appended claims.

1. An electrical apparatus comprising at least one electrical component in thermal contact with a heat transfer fluid, wherein the heat transfer fluid comprises by weight percent of the fluid >95% at least one ester of a C₅-C₉ monocarboxylic acid and a C₅-C₉ monoalcohol, the at least one ester having a carbon number of less than 17 the heat transfer fluid not comprising more than 80% by weight 2-ethylhexyl octanoate.

2. The electrical apparatus, as claimed in claim 1, further comprising a heat source in thermal contact with the heat transfer fluid to permit heat to be transferred by the heat transfer fluid from the heat source to the at least one electrical component.

3. The electrical apparatus, as claimed in claim 1, further comprising a heat sink in thermal contact with the heat transfer fluid to permit heat to be transferred by the heat transfer fluid from the at least one electrical component to the heat sink.

4. The electrical apparatus, as claimed in claim 1, wherein the at least one electrical component is immersed in the heat transfer fluid.

5. The electrical apparatus, as claimed in claim 1, wherein the apparatus is configured to supply heat to the at least one electrical component when the at least one electrical component is below a first temperature, and to remove heat from the at least one electrical component when the at least one electrical component is above a second temperature.

6. The electrical apparatus, as claimed in claim 1, wherein the at least one electrical component comprises a battery.

7. The electrical apparatus, as claimed in claim 5, wherein the battery is a lithium ion battery.

8. The electrical apparatus, as claimed in claim 1, wherein the heat transfer fluid comprises by weight percent of the fluid >95% one ester of a C₅-C₉ monocarboxylic acid and a C₅-C₉ monoalcohol.

9. The electrical apparatus, as claimed in claim 7, wherein the one ester of a C₅-C₉ monocarboxylic acid and a C₅-C₉ monoalcohol is the only ester of a C₅-C₉ monocarboxylic acid and a C₅-C₉ monoalcohol present in the heat transfer fluid.

10. The electrical apparatus, as claimed in claim 1, wherein the at least one ester of a C₅-C₉ monocarboxylic acid and a C₅-C₉ monoalcohol comprises one or more of the following features:
the C₅-C₉ monocarboxylic acid is an acyclic monocarboxylic acid;
the C₅-C₉ monocarboxylic acid is a linear monocarboxylic acid;
the C₅-C₉ monocarboxylic acid is a branched monocarboxylic acid;
the C₅-C₉ monoalcohol is an acyclic monoalcohol;
the C₅-C₉ monoalcohol is a linear monoalcohol;
the C₅-C₉ monoalcohol is a branched monoalcohol;
the C₅-C₉ monoalcohol is a primary monoalcohol;
the C₅-C₉ monoalcohol is a secondary monoalcohol; or
the C₅-C₉ monoalcohol is a tertiary monoalcohol.

11. The electrical apparatus, as claimed in claim 1, wherein the ester comprises:
2-octyl pentanoate, 2-octyl hexanoate, 2-octyl heptanoate, 2-hexyl nonanoate, isononyl hexanoate, 7-methyloctanyl hexanoate, 2-ethylhexyl heptanoate, 2-octyl octanoate, 2-ethylhexyl 2-ethylhexanoate, or mixtures thereof.

12. The electrical apparatus, as claimed in claim 1, wherein the carbon number is 13 or more.

13. The electrical apparatus, as claimed in claim 1, wherein the heat transfer fluid comprises at least one functional additive selected from the group consisting of anti-oxidants, metal deactivators, friction modifiers, corrosion inhibitors, antifoam additives, detergents, extreme pressure additives, anti-wear additives, and thermally conductive particles.

14. A method of operating electrical apparatus as claimed in claim 1, comprising transferring heat from the heat transfer fluid to the at least one electrical component, and operating the at least one electrical component once a threshold temperature is exceeded.

15. A heat transfer fluid comprising by weight percent:
>95% at least one ester of a C₅-C₉ monocarboxylic acid and a C₅-C₉ secondary monoalcohol, the at least one ester having a carbon number of less than 17 the heat transfer fluid not comprising more than 80% by weight 2-ethylhexyl octanoate; and
at least one functional additive selected from the group consisting of anti-oxidants, metal deactivators, friction modifiers, corrosion inhibitors, antifoam additives, detergents, extreme pressure additives, and anti-wear additives.

16. The heat transfer fluid, as claimed in claim 14, in which the functional additives comprise by weight percent of the fluid:
≥0.1% anti-oxidant;
≥0.001% metal deactivator; and
optionally, in which the functional additives comprise by weight percent of the fluid:
0.1-1.0% anti-oxidant; or
0.001-0.05% metal deactivator.

17. The heat transfer fluid, as claimed in claim 15, wherein the heat transfer fluid comprises >95% one ester of a C₅-C₉ linear monocarboxylic acid and a C₅-C₉ linear secondary monoalcohol.

18. The heat transfer fluid, as claimed in claim 17, wherein the one ester of a C₅-C₉ linear monocarboxylic acid and a C₅-C₉ linear secondary monoalcohol is the only ester of a C₅-C₉ linear monocarboxylic acid and a C₅-C₉ linear secondary monoalcohol present.

19. The heat transfer fluid, as claimed in claim 15, the at least one ester of a C₅-C₉ monocarboxylic acid and a C₅-C₉ monoalcohol comprises one or more of the following features:
the C₅-C₉ monocarboxylic acid is an acyclic monocarboxylic acid;
the C₅-C₉ monocarboxylic acid is a linear monocarboxylic acid;
the C₅-C₉ monocarboxylic acid is a branched monocarboxylic acid;
the C₅-C₉ monoalcohol is an acyclic monoalcohol;
the C₅-C₉ monoalcohol is a linear monoalcohol;
the C₅-C₉ monoalcohol is a branched monoalcohol;
the C₅-C₉ monoalcohol is a primary monoalcohol;
the C₅-C₉ monoalcohol is a secondary monoalcohol; or
the C₅-C₉ monoalcohol is a tertiary monoalcohol.

20. The heat transfer fluid, as claimed in claim 15, wherein the ester comprises:
2-octyl pentanoate, 2-octyl hexanoate, 2-octyl heptanoate, 2-hexyl nonanoate, isononyl hexanoate, 7-methyloctanyl hexanoate, 2-ethylhexyl heptanoate, 2-octyl octanoate, 2-ethylhexyl 2-ethylhexanoate, or mixtures thereof.

21. The heat transfer fluid, as claimed in claim 15, wherein the carbon number is 13 or more.

22. The heat transfer fluid, as claimed in claim 17, wherein the C₅-C₉ linear monocarboxylic acid is heptanoic acid and the C₅-C₉ linear secondary monoalcohol is 2-octanol.

23. A method of using a heat transfer fluid comprising by weight percent of the fluid >95% at least one ester of a C₅-C₉ monocarboxylic acid and a C₅-C₉ monoalcohol and having a carbon number of less than 17, the heat transfer fluid not comprising more than 80% by weight 2-ethylhexyl octanoate, the method comprising using the heat transfer fluid to deliver heat to at least one electrical component at a temperature between 0° C. and −40° C.
